(19) United States
(12) Patent Application Publication
(10) Pub. No.: US 2026/0191245 A1
(43) Pub. Date: Jul. 9, 2026

(54) SIZE-CONTROLLABLE, EMULSIFYING PULSE PROTEIN MICROGELS AND METHODS OF PREPARATION

(71) Applicant: The Governors of the University of Alberta, Edmonton (CA)

(72) Inventor: Lingyun CHEN, Edmonton (CA)

(21) Appl. No.: 19/442,682

(22) Filed: Jan. 7, 2026

Related U.S. Application Data
(60) Provisional application No. 63/742,668, filed on Jan. 7, 2025.

(51) Int. Cl. A23L 27/00; A23L 11/00

(52) U.S. Cl. CPC A23L 27/80; A23L 11/05

(57) ABSTRACT

A size-controllable microgel formed from pulse proteins is disclosed. The microgel has a monodisperse particle size and is formed by segregative phase separation with a solution of proteins and a solution of polysaccharide at a pH above the isoelectric point of the proteins. In some examples, the pulse proteins are lentil or fava bean proteins and the polysaccharide is alginate. The size of the microgel particles may be controlled by varying the mass ratio of proteins to polysaccharide.

### FIELD

The present invention generally relates to pulse protein gels, and more particularly, to size-controllable pulse protein microgels suitable for use as an emulsifier, and methods of preparation thereof.

### BACKGROUND

Proteins are a major source for fabricating biopolymer microgels due to their biodegradability, easy availability and food-grade quality. Compared to the extensive studies on the fabrication of microgels from animal proteins such as whey protein, casein and lactoferrin, studies using proteins from plants such as pulses (dry peas, lentils, fava beans, chickpea, etc.) are relatively new.

Pulses are legume crops that are harvested for their dry seeds. Pulse-based protein alternatives have attracted industrial interest due to rising consumer demand and environmental concerns. Compared to animal proteins, pulse proteins offer several advantages, including health benefits, vegan-friendly nature, lower price, reduced environmental impact, fewer religious restrictions, and the promotion of animal welfare. The emissions per kilogram of protein are lowest for pulses, followed by grains, eggs, fish, and highest for beef. Therefore, transitioning from animal protein-based to pulse protein-based foods is desirable to provide safe, sustainable, and healthy food for the growing population.

Methods to form microgels can be classified into molecular association-based methods and mechanical methods. Conventional methods such as coacervation (molecular association-based method), spray drying and shearing (mechanical methods), however, do not exhibit sufficient control over microgel sizes. Accordingly, although these methods are commonly used, they result in microgels with high polydispersity and requiring high energy input. The morphology, size, and size distribution of microgels significantly impact their various applications. The poor control of microgel size distribution or high polydispersity may demonstrate drawbacks in the drug encapsulation and release behavior in the gastrointestinal tract.

Mechanical microfluidic fabrication has been reported to offer precise control over the size and shape of microgel particles. Microfluidic devices generate microgels by forming monodisperse precursor droplets through emulsification, followed by gelation of precursor droplets. However, microfluidic methods require specifically designed microfluidic devices. Moreover, the microgel output is typically in the range of microliters per minute, indicating a low microgel production rate and making it difficult to scale up. Therefore, producing a facile and cost-effective method for producing uniformly sized microgels remains challenging and highly desirable.

There remains a need in the art for size-controllable pulse protein based gels which are relatively monodisperse.

### SUMMARY

Disclosed examples provide for preparing pulse protein microgels using protein-polysaccharide segregative phase separation. In some examples, the pulse proteins comprise lentil and/or fava bean proteins. In some embodiments, the polysaccharide comprises alginate. In some embodiments, the polysaccharide remains in the continuous phase and is removed from the gel. In some embodiments, some polysaccharide may remain linked to the protein gel network and can modify the surface chemistry to certain extent, for example modify surface charge and hydrophobicity.

In at least one example, the size of the microgels is controllable. For example, for lentil bean proteins, the microgel size is controllable to 3 μm, 7 μm or 15 μm. For fava beans, it is controllable to 3 μm, 7 μm or 19 μm.

The disclosed fabrication method (via segregative phase separation) can efficiently produce microgels of controlled size with low energy consumption. As provided herein, the size of the microgel is controllable by changing a protein to polysaccharide ratio when performing segregative phase separation. In some examples, the protein to polysaccharide mass ratio may be in the range from about 1:1 to about 12:1. For example, a mass ratio of between about 5:4 to about 10:1 results in microgel size of about 3 μm to about 15 μm respectively for lentil protein, and about 3 μm to about 19 μm for fava protein.

Microgels described herein can be used to stabilize an emulsion with varying protein and oil concentrations. Compared to untreated protein-stabilized emulsions, which creamed after one day, the microgel-stabilized emulsions showed no creaming after 28 days.

Without restriction to a theory, microgels described herein can stabilize emulsions through distinct mechanisms. Confocal laser scanning microscopy images illustrate that the smallest microgels at 3 μm can absorb at the oil-water interface, forming Pickering emulsions and effectively stabilizing emulsions with 25% and 50% oil with nearly no creaming after one-month of storage.

Larger microgels (7 μm and 20 μm) demonstrate reduced emulsifying stability at 25% oil but similar stability at 50%. They disperse in the continuous phase, contributing to emulsion stability through steric hindrance and a gelling effect.

Accordingly, the disclosed results demonstrate improvements in the emulsifying properties of plant proteins and, in turn, their usefulness for wide applications in food formulations to create stable and healthy low-fat food products.

In view of the foregoing, and in accordance with at least one broad aspect, there is provided a method for preparing size-controllable pulse protein microgels comprising:
mixing a source of pulse protein with a source of polysaccharides to form pulse protein particles via segregative phase separation; and
heating the mixture to induce particle gelation.
   In some embodiments, the polysaccharides remaining in the continuous phase are removed to isolate the pulse protein microgels.

In some examples, the pulse protein source comprises lentil and/or fava protein isolate solution.

In some examples, the polysaccharide source is an alginate solution.

In some examples, the mixing occurs at a pH at or above the isoelectric point of the protein.

In some examples, the mixing occurs at a pH of 8.5 for lentil protein, and a pH of 7.5 for fava protein.

In some examples, the mixing volume ratio of protein-to-polysaccharide comprises 1:4, 1:1 or 2:1 to change the microgel size, respectively, from 3 μm, 7 μm and 15 μm (lentil)/19 μm (flava).

In some examples, the size of the microgels is controlled at 3 μm and 7 μm particle size.

In some examples, lentil protein microgels (LPM) at 3 μm are used for forming oil-in-water Pickering emulsions, with an oil content between about 25% to about 50% oil.

In some examples, the microgels are used to produce low-fat emulsions.

In another broad aspect, there is provided an oil-in-water emulsion comprising pulse protein microgels having sizes in a range of 3 μm, 7 μm or 15 μm (lentil)/19 μm (flava).

In some examples, the emulsion comprises pulse protein microgels at a concentration of 1.5% or 3%.

In some embodiments, described are microgels, methods of producing microgels and methods of using the microgels which combine any steps, features or elements described herein, in any combination or subcombination. Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIGS. 1A-1D are optical microscopic images exemplifying the influence of pH on the formation of lentil protein microgels at a protein-to-alginate ratio of 1:1, and demonstrating formation at: (i) a natural pH of 6.64 (FIG. 1A), (ii) a pH of 7.5 (FIG. 1B), (iii) a pH of 8.5 (FIG. 1C), and (iv) a pH of 9.5 (FIG. 1D). The scale bar is equal to 10 μm.

FIG. 2 is schematic illustration of the formation of pulse protein microgels, in accordance with disclosed examples.

FIGS. 3A-3C are optical microscopic images exemplifying the influence of protein-to-alginate ratios on the particle size of protein microgels for lentil (“L”) microgels (pH 8.5) at protein-to-polysaccharide ratios of (i) 1:4: M_{L14} (FIG. 3A), (ii) 1:1 M_{L11} (FIG. 3B), and (iii) 2:1 M_{L21} (FIG. 3C). The scale bar is equal to 10 μm.

FIGS. 4A-4C are optical microscopic images exemplifying the influence of protein-to-alginate ratios on the particle size of protein microgels for fava (“F”) microgels (pH 7.5) at protein-to-polysaccharide ratios of (i) 1:4 M_{F14} (FIG. 4A), (ii) 1:1 M_{F11} (FIG. 4B), and (iii) 2:1 M_{F21} (FIG. 4C). The scale bar is equal to 10 μm.

FIGS. 5A-5B include (i) a scanning electron microscopic (SEM) image of M_{L11} (FIG. 5A), and (ii) a cross-section structure of an individual M_{L11} (FIG. 5B). The scale bar is equal to 1 μm.

FIGS. 6A-6B include (i) a scanning electron microscopic (SEM) image of M_{F11} (FIG. 6A), and (ii) a cross-section structure of an individual M_{F11} (FIG. 6B). The scale bar is equal to 1 μm.

FIGS. 7A-7B are plots of the size distribution (volume mean diameter D_{3,2}) of an example prepared microgel using lentils (FIG. 7A) and fava (FIG. 7B).

FIGS. 8A-8B are plots of zeta potential of proteins, heated proteins and microgels from lentil (FIG. 8A) and fava (FIG. 8B).

FIGS. 9A-9B are plots of deconvoluted Fourier-transform infrared (FTIR) spectra of the amide I band (1600-1700 cm⁻¹) for lentils (FIG. 9A), and fava (FIG. 9B).

FIGS. 10A-10B show plots exemplifying the influence of oil concentration in an O/W emulsion for microgels made from lentils for: (i) 25% oil (FIG. 10A), and (ii) 50% oil (FIG. 10B), for different microgel concentrations (1.5% and 3%), microgel sizes (M_{L14}, M_{L11} and M_{L21}) on creaming stability of an O/W emulsion during storage for four (4) weeks. The data represent the mean values±SD (n=3).

FIG. 11 shows confocal microscopy (CLSM) images of O/W (oil-in-water) emulsions stabilized by 3% lentil microgels at (a) M_{L14} 25% oil fraction, (b) M_{L14} 50% oil fraction small size, (c) M_{L11} at 25% oil fraction, and (d) M_{L11} at 50% oil fraction. Oil droplets were stained with Nile red (red), while microgels were stained with fast green (green) and the merged images. The scale bars are equal to 20 μm.

FIGS. 12A-12B are plots exemplifying the influence of oil concentration on the droplet size (D_{4,3}) of freshly prepared emulsions and for microgels made of lentils at: (i) 25% oil (FIG. 12A), and (ii) 50% oil (FIG. 12B), for different microgel concentrations (1.5% and 3%), and microgel sizes (M_{L14}, M_{L11} and M_{L21}).

FIGS. 13A-13F show plots of rheological properties of O/W emulsions using microgels made of lentils with: (i) 25% oil contents (FIGS. 13A-13C), and (ii) 50% oil contents (FIGS. 13D-13F), stabilized by untreated lentil protein (LP) and lentil microgels with different sizes and two concentrations (1.5% and 3%), and further showing (i) shear-rate dependence of viscosity (FIGS. 13A and 13D), and (ii) a frequency sweep (FIGS. 13B-13C and 13E-13F).

### DETAILED DESCRIPTION

Disclosed examples relate to pulse protein microgels with high emulsifying performance, and methods of preparation thereof.

### I. DEFINITIONS

Any term or expression not expressly defined herein shall have its commonly accepted definition understood by a person skilled in the art. As used herein, the following terms have the following meanings.

“Polysaccharide” refers to a carbohydrate polymer comprising chains of monosaccharide residues. Polysaccharides can include water soluble polymers such as carboxymethyl cellulose, pectin, guar, inulin, dextran, carrageenan, beta-glucan, and alginate. “Alginate” refers to a naturally occurring, anionic polysaccharide primarily composed of β-D-mannuronic acid (M) and α-L-guluronic acid (G) residues. Alginate is typically derived from brown algae or produced by certain bacterial strains. Its molecular structure and composition enable the formation of hydrogels when used in the methods described herein.

“Microgels” or “Biopolymer microgels” refer to gel particles (e.g., soft particles) usually ranging from 100 nanometers to 100 micrometers in size, and comprising of a three-dimensional network formed by cross-linked biopolymer molecules. In some examples, microgels can effectively entrap solvents within them. In some embodiments, microgels are colloidal entities that simultaneously have polymer-like and particle-like features. An individual microgel particle consists of a three-dimensional (3D) network of cross-linked polymer molecules to retain a large amount of solvent (typically water). The microgels have large surface-to-volume ratio and high sensitivity to the environment, thus can offer advanced functionalities over macro gels and solid particles

“Pickering emulsion” refers to a type of emulsion stabilized by solid or colloidal particles that adsorb at the interface between two immiscible liquids, such as oil and water. Unlike surfactant-based emulsions, the stabilization in Pickering emulsions arises from the irreversible attachment of the particles, which form a mechanical barrier to droplet coalescence. The properties of the emulsion, such as droplet size and stability, depend on the type, size, and surface chemistry of the particles, as well as external factors like pH and ionic strength.

“Pulse proteins” refer to proteins derived from pulse crops, which are edible seeds of leguminous plants, including but not limited to peas, lentils, fava and chickpeas.

“Segregative phase separation method” refers to a process in which two or more components of a mixed system, such as polymers, proteins, or other macromolecules, separate into distinct phases due to thermodynamic incompatibility. Without limitation to theory, this separation occurs to minimize the free energy of the system, typically driven by differences in solubility, polarity, or molecular interactions.

As referenced herein, microgels with protein-to-alginate ratios (m: m) of 5:4, 5:1 and 10:1 are noted as M_{L14}, M_{L11} and M_{L21}, or as M_{F14}, M_{F11}, M_{F21}, depending on whether lentil proteins are used or fava protein proteins are used.

### II. GENERAL OVERVIEW

Microgels demonstrate great potential in various applications in the biomedical, cosmetics, food and nutrition fields, primarily due to their flexible structures, tunable softness and size, high biodegradability, and responsive behavior to external stimuli. For example, microgels can function as food texture modifiers by changing the viscosity because they influence the fluid flow dynamics. Microgels can also function as a fat replacement by mimicking fat droplets to create a creamy texture. Microgels can also be used as bioactive compounds delivery vehicles due to their retention and release properties owing to their open network structure.

In some embodiments, microgels described herein can exhibit desirable and unique interfacial activities which show promising opportunities for stabilizing foams and emulsions. Microgels described herein can adsorb at the oil-water or air-water interfaces and function as stabilizers for Pickering emulsions and foams.

In some embodiments, described herein are segregative phase separation methods for microgel preparation using pulse proteins, analogous to methods used to prepare whey protein microgels with controlled size. Segregative phase separation, also known as thermodynamic incompatibility, occurs when the two polymers have a strong repulsive force. When pH is above the protein's isoelectric point, negative charges on protein and polysaccharide molecules result in phase separation with one phase rich in protein and the other in polysaccharide. This system then induces the formation of a water-in-water (W/W) emulsion with droplets of protein solution dispersed in the alginate continuous phase. Afterward, the thermal treatment triggers the gelation of protein to form microgel particles.

In some embodiments, this method is preferred for protein microgel production at least in part because of low energy consumption, absence of organic solvents, and simplicity in equipment. It operates with greater energy efficiency compared to high-pressure homogenization. Additionally, compared to emulsion-based processes such as microfluidics, it avoids the need for organic solvents and surfactants due to low surface tension of w/w emulsions. Furthermore, it employs simple and readily available equipment, in contrast to the sophisticated apparatus required for microfluidics.

Compared to whey protein microgels, pulse protein microgels are softer due to the lower number of disulfide bonds in their structure. This reduction in disulfide bonds contributes to their decreased stiffness and greater flexibility.

In some embodiments, lentil and/or fava beans are used as the source for pulse proteins. Lentil is used because it is a cool-season crop and developing novel food applications using lentil protein may benefit the food industry and bolster breeding programs. Fava beans are used for their high protein content, which exceeds that of other pulses like peas and common beans.

In some embodiments, the size and morphology of microgels is controlled by changing the biopolymer ratios, i.e., protein-to-polysaccharide ratio (such as the protein-to-alginate ratio).

In at least one example, the disclosed pulse protein microgels are used to produce stable emulsions, including stable Pickering emulsions or foam.

Traditional emulsions use surfactants with small molecular sizes (e.g. sorbitan esters) to stabilize oil droplets. These emulsifiers are absorbed in the oil-water interface to reduce the interfacial energy. However, concerns about the artificial nature, unfamiliarity, and potential toxicity of small molecule surfactants have been raised.

Unlike traditional emulsions where emulsifiers can easily desorb from the interface, Pickering emulsions are formed with solid or colloidal particles that absorb irreversibly to the interface and form dense layers at the interface, which provides Pickering emulsions with increased stability. While Pickering emulsions can be formed using inorganic particles such as silica as stabilizers, plant protein microgels can offer several advantages such as biocompatibility, biodegradability, and suitability in food applications due to their natural origin.

To this effect, the properties of Pickering emulsions vary with different legume proteins due to their distinct structures. As provided herein, the emulsifying capabilities of microgels of varying sizes are exemplified at different oil fractions and protein concentrations. The oil droplet size and rheological properties of these emulsions are demonstrated in detail.

In some embodiments, in terms of emulsifying capacity, disclosed lentil microgels (3%) exhibit a greater ability to form stable emulsions compared to native lentil protein (3%), with little or no creaming observed after one month of storage.

Microgels, with different sizes, can stabilize emulsions by different mechanisms. For example, lentil microgels at 3 μm exhibit greater emulsifying stability by attaching to the oil/water interface and forming Pickering emulsions. Microgels with bigger sizes at 7 μm break down into free proteins and form traditional emulsions stabilized by the amphiphilic lentil proteins. Pickering emulsions exhibit higher viscosity compared to traditional emulsions due to the formation of an interfacial layer around the oil droplets, which impedes their movement.

A composition comprising excess microgel particles (e.g. not involved in emulsion stabilization) present in the continuous phase produce a three-dimensional network structure, further contributing to the increased viscosity. The rheological studies on emulsions indicate that those stabilized by microgels containing 25% oil achieve similar or improved viscosity and texture compared to emulsions stabilized by untreated proteins with 50% oil content. This demonstrates the promising potential of plant microgels as substitutes for fats, enabling the production of low-fat products that cater to market demands while addressing health considerations.

It is believed that disclosed examples offer a novel method for producing plant protein microgels and using them as natural stabilizers for oil-in-water emulsions, offering an alternative to synthetic surfactants and stabilizers in the development of plant-based foods.

### III. EXAMPLE PROCESS

FIG. 2 exemplifies a process 200 for producing pulse protein microgels. Process 200 uses a segregative phase separation method. As shown, at 202, the pulse protein (e.g., lentil or fava) is mixed with a polysaccharide source. In some examples, the polysaccharide source is an alginate solution. As provided herein, the protein-to-polysaccharide ratio is configurable to control the size and morphology of the pulse protein microgels. The mixing can occur under pH conditions which are at or greater than the isoelectric point (pI) of that protein.

In particular, the mixing results in segregative phase separation resulting in distinct protein-rich and alginate-rich phases. The formed particles are therefore rich in protein.

To this effect, at alkaline pHs, both alginate and pulse protein solutions carry negative charges, generating strong repulsive forces. Additionally, higher concentrations of mixtures lead to increased steric exclusion.

At 204, in some examples, the mixture is additionally heated to allow for particle formation by protein denaturation. Heat-induced protein denaturation further increases thermodynamic incompatibility for the purpose of segregative phase separation. The phase-separated biopolymer mixture forms a water-in-water emulsion, with spherical protein microdomains dispersed in a continuous alginate phase.

At 206, further heating is applied to induce protein droplet gelation. Thermal gelation of legume globulin proteins involves three steps: protein unfolding (denaturation), aggregation, and association of aggregates to form a three-dimensional network.

At 208, the polysaccharide source (e.g., alginate) is removed to retain only the pulse protein microgels. For example, centrifugation is used to remove alginate and denatured proteins. The remaining pellets are then the isolated microgels. Some small amount of polysaccharide may be associated with the microgel surface.

i. Example Materials

In disclosed examples, lentil protein isolate (“LPI”, 85%, w/w) was prepared from dehulled lentil flour at the Food Processing and Development Centre (Leduc, Alberta, Canada). The fava bean protein isolate (“FPI”, Nourish 90, 90% w/w) was from Top Health Ingredients (Top Health Ingredients, Inc., Alberta, Canada). The Milli-Q water purified by Milli-Q Advantage A10 system (EMD Millipore Corporation, MA, USA) was used in these experiments. Canola oil (Rimini, 100% pure canola oil) was purchased from the Costco Grocery (Alberta, Canada).

All reagents and chemicals used were of analytical grade purchased from Sigma-Aldrich (MO, USA) and Thermo Fisher Scientific (Ontario, Canada).

ii. Example Preparation of Plant Protein Microgels

In disclosed examples, the LPI and FPI were dissolved in Milli-Q water at a ratio of 15% (w/v) for one night with moderate stirring. Sodium azide (0.02%, w/v) was added to prevent bacterial growth. Then, these suspensions were centrifugated at 10000 g for 20 mins to remove insoluble compositions. The supernatants were collected as protein stock solutions and the protein concentrations were determined at 10% (w/v). The alginate (2%, w/v) was dissolved in Milli-Q water and stirred overnight to prepare alginate stock solution.

The pH of the protein solutions was adjusted in the range of 6 to 10 using 6M NaOH to find the optimal pH for the microgel formation. The optimal pH values for the LPI and FPI were determined at pH 8.5 and pH 7.5, respectively.

The biopolymer solutions were prepared by mixing the protein solutions and alginate solution with different volume ratios (1:4, 1:1 and 2:1) by moderate stirring for 15 minutes. The mixture solutions were heated at 96° C. for 1 hour in a water bath. Then samples were cooled down and stored at 4° C. overnight.

The cooled microgel suspensions were then centrifuged (17000 g, 20 min) to remove alginate and unconverted protein to get isolated protein microgels. The pellets (microgels) were collected, and the supernatants were removed.

The pellets were then dispersed in deionized water and centrifuged again, and repeated the washing step three times. The final pellets were regarded as isolated microgels and stored in the refrigerator at 4° C. for following studies.

### IV. EXAMPLE TEST RESULTS FOR CHARACTERIZATION OF PLANT PROTEIN MICROGELS AND HEATED PROTEIN SOLUTIONS

The below test results were determined based on the materials and example preparation method disclosed above.

All experiments were performed at least in triplicates and results were presented as mean values±standard deviations. All statistical analysis were performed by the SPSS software (SPSS, INC., Chicago, IL, USA). T-test or one-way analysis of variance (ANOVA) with post hoc Tukey's test were used to determine the statistically significant differences between results. The p-value <0.05 was considered significant.

i. Formation and Morphology

The morphology of plant protein microgels was observed by an optical microscope, and figures were taken with a photographic camera (OptikamB3 Digital Camera, Optika, Italy). Moreover, the scanning electron microscopy (SEM) imaging of dehydrated microgels was performed on a Helios Hydra UX PFIB-SEM (Thermo Scientific, Inc.) with an acceleration voltage of 5 kV. The cross-sectional samples were prepared using the focused ion beam (FIB) technique in a Helios Hydra UX dual-beam plasma focused ion beam/scanning electron microscope (PFIB/SEM).

The dehydrated microgels for SEM and PFIB/SEM observation were prepared according to reference [1]. Briefly, the isolated microgels were dispersed in the tert-Butyl alcohol (TBA) to replace the water in the microgel matrix. The pellets were then quenched using liquid N₂ and freeze-dried. Then samples were coated with 10 nm gold in a Leica EM ACE 600 high-vacuum coater.

In one example, pulse protein and alginate concentrations were set at 10% w/w and 2% w/w. In preliminary tests, lower biopolymer concentrations resulted in a single-phase mixture of alginate and protein without microgel formation.

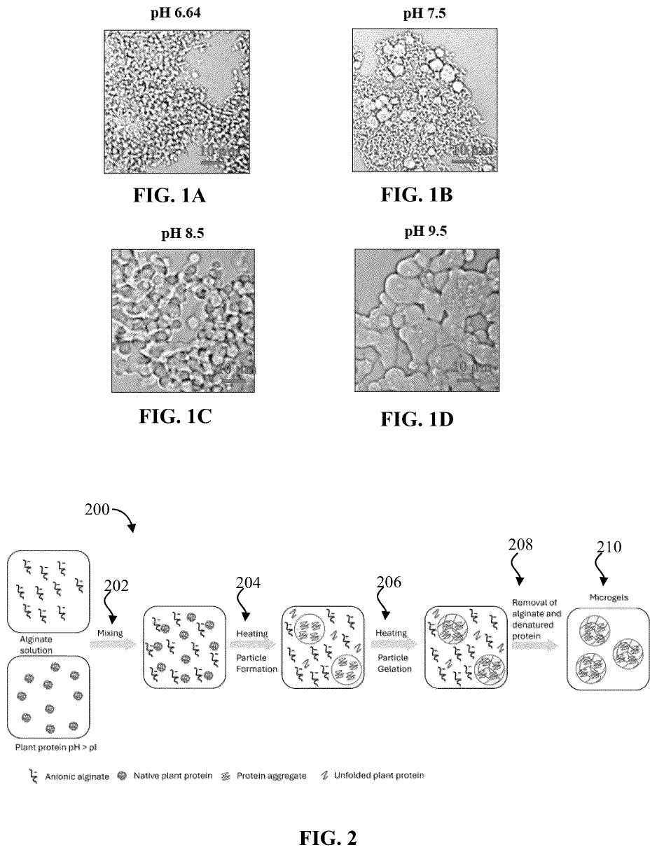

In the first step, the impact of pH on the microgel formation was evaluated. The pH of pulse protein solution influenced both its solubility and structural unfolding during gel formation. The heated mixtures of lentil protein and alginate at various pH levels were observed using optic microscopy (FIGS. 1A-1D).

Unlike whey protein microgels that formed spherical microgels at neutral pH 7, both phase separation and lentil protein aggregation occurred at the same time at pH 7.5. From FIG. 1B, the clear spherical microgels formed and were surrounded by amorphous protein aggregates. Compared to whey protein, pulse proteins exhibit relatively low solubility at neutral pH.

Despite the removal of most of the insoluble components during centrifugation, some insoluble proteins remained in the supernatant. Without limitation to theory, it is hypothesized that this difference in solubility or surface charge might explain the observed phenomena: proteins with higher solubility and surface charge were more likely to form microgels with water entrapped in the matrix, while those with lower solubility and net surface charge tend to form protein aggregates. The solubility and surface charge of legume proteins can be controlled by changing the pH of the protein solution. Generally, the legume proteins reach the lower water solubility in the pH range from 4 to 6 because of being close to the isoelectric point.

Therefore, as shown in FIG. 1A, at the native pH 6.64, more protein aggregates formed because of a relatively low electrostatic repulsion between protein molecules, and proteins are more likely to go through fast random aggregation. The competition between protein aggregation and phase separation can be controlled by changing the pH of the protein solutions.

When increasing pH to 8.5 (FIG. 1C), lentil proteins formed spherical microgels without any irregular protein aggregates due to increased solubility and enhanced electrostatic repulsion between proteins. However, when pH=9.5 (FIG. 1D), repulsive forces were stronger than the attractive forces (e.g., hydrophobic interactions, hydrogen bonds, and disulfide bonds), leading to heterogeneous size distribution and a loose, soft texture. This may be due to strong repulsion inhibiting protein-protein interactions. Therefore, the pH was set at 8.5 for lentil microgel formation.

Following a similar approach by adjusting the pH of the protein solution to create microgels, the optimal pH for fava protein was determined to be 7.5. Without limitation to theory, the difference might be related to the different structures and charge properties of these pulse proteins.

The successful development of microgels from lentil and fava proteins demonstrates that the protein-polysaccharide segregative phase separation mechanism is effective for fabricating microgels from pulse proteins.

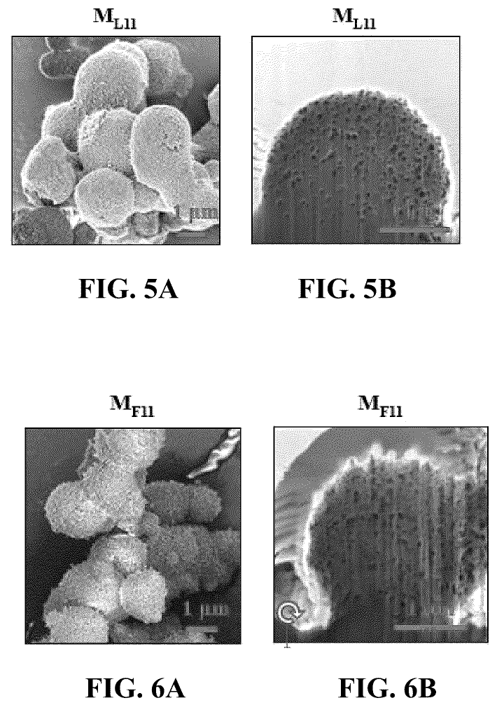

From FIGS. 5 and 6 both the optical microscopic images and SEM images demonstrated spherical shapes and relatively consistent size distributions for lentil and fava protein microgels. The dehydration during sample preparation for SEM observations caused a reduction in the size of the microgels (FIGS. 5A and 6A). The internal structures of the pulse protein microgels exhibited densely crosslinked protein networks with uniform pore distribution (FIGS. 5B and 6B).

Pulse protein microgels formed a spherical shape due to their formation from a water-in-water emulsion. The internal structure showed a typical hydrogel network with a three-dimensional porous architecture, as the lyophilization process removed water via sublimation.

ii. Particle Size

The particle size distribution of plant protein microgels was determined by laser diffraction using a Mastersizer 3000 (Malvern Instruments Ltd., Worchester, UK). The microgels were dispersed in distilled water until laser obstruction >5% was obtained. The surface-weighted mean diameter (D_{3,2}) was used to represent the average particle size.

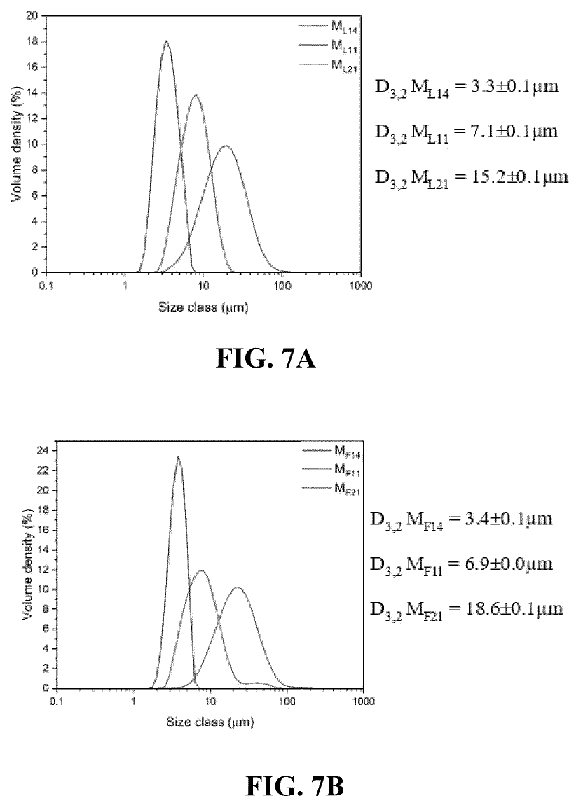

Particle size (D_{3,2}) measurements demonstrated that the microgels had a monomodal and narrow size distribution, characterized by a distinct narrow peak, especially for the smaller-sized microgels (FIGS. 7A and 7B).

Additionally, modulating the protein-to-alginate ratios enabled precise control of the microgel size. For lentil-based microgels, a protein-to-alginate ratio of 1:4 produced microgels with a mean diameter of 3.3 μm (M_{L14}). As the ratio was increased to 1:1 and 2:1, the microgel sizes increased progressively to 7.1 μm (M_{L11}) and 15.2 μm (M_{L21}), respectively (FIG. 7A).

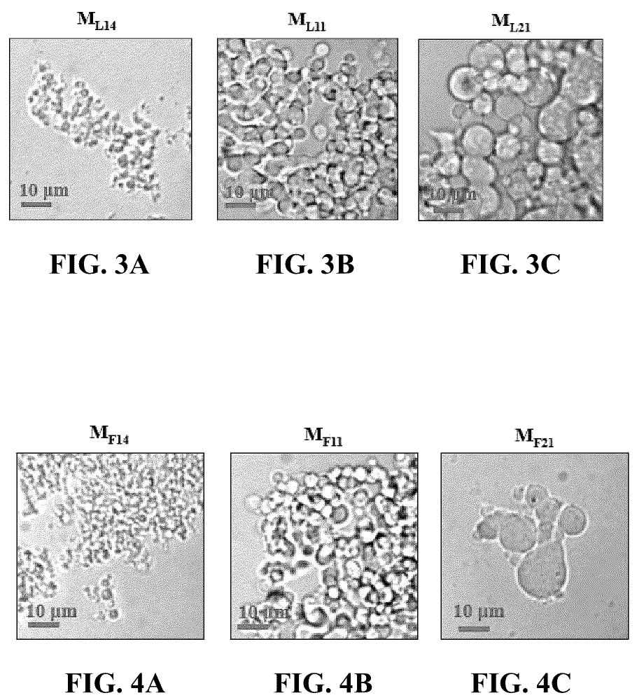

Fava protein microgels showed a similar pattern, with an average size of 3.6 μm at a 1:4 ratio, increasing to 6.9 μm and 18.6 μm at 1:1 and 2:1 ratios, respectively (FIG. 7B). These results were consistent with the morphology of microgels observed by optical microscopy, as shown in FIGS. 3A-3C and FIGS. 4A-4C.

These results indicate that varying the protein-to-alginate volume ratio can provide a convenient method to modify microgel size. Without limitation to theory, one explanation is that higher alginate concentration or a lower protein-to-alginate ratio enhances the excluded volume effect, as alginate chains occupy more space, reducing the available space for the protein solution. This enhances depletion interactions, leading to smaller protein microdomains during phase separation before gelation.

The volume ratios above correspond to mass ratios based on a 10% concentration of the protein and a 2% concentration of the polysaccharide.

Increasing alginate concentration raises the mixture's viscosity, slows protein microdomain growth and ultimately reduces microgel size. As a result, microgel size can be controlled by adjusting the protein-to-polysaccharide ratio.

It was noteworthy that whey protein microgels could be reduced to a size of 1 μm when the protein-to-polysaccharide volume ratio was 1:4, while plant protein microgels were around 3 μm at this ratio. Whey protein may have a better gelling efficiency than pulse proteins, due to high solubility of whey proteins, which allows more proteins to participate in gel formation.

Pulse protein showed greater structural resistance to thermal treatment than whey protein, taking around 1 hour to denature compared to 15 minutes. The longer denaturation time likely promoted microdomain growth, resulting in larger microgel size.

iii. Zeta Potential

Zeta potential analysis is employed to evaluate the surface charge of the protein and microgel samples, which can indicate the colloidal stability. All negative values suggested that the proteins carry the negative charges due to the pH values (7.5-8.5) being higher than the isoelectric point of lentil and fava proteins (pH 4-5). Zeta potential values ranging from −16 to −30 mV represent the threshold for delicate dispersion, while values between −31 and −40 mV indicate the moderate stability.

More broadly, the zeta-potential of the protein solutions, heated protein solutions and microgel suspensions (5 mg/mL protein concentration) is determined by the dynamic light scattering (DLS) technique using a Zetasizer Nano ZS (Malvern Instruments Ltd., Worcestershire, UK) at 25° C. All size and charge measurements were repeated three times.

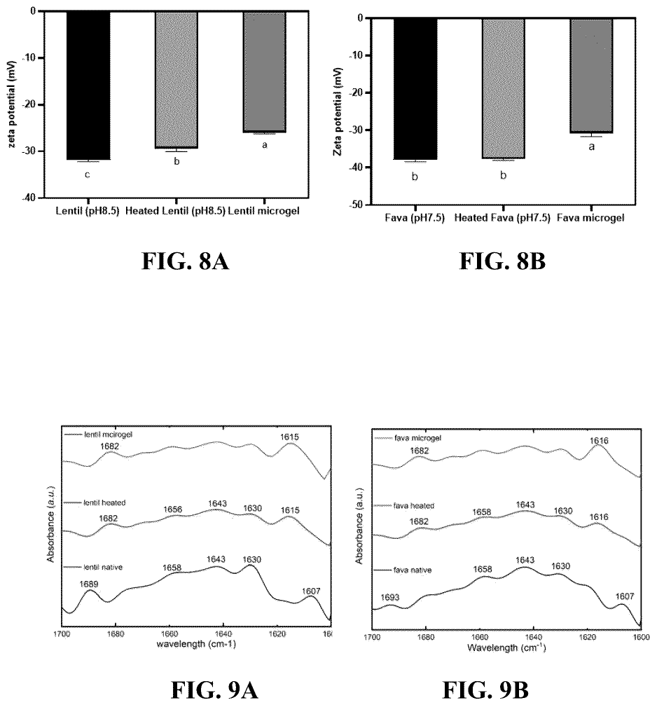

As shown in FIGS. 8A-8B, the zeta-potential value of native lentil protein at pH 8.5 is −31.9 mV, while native fava protein achieves −38.0 mV at pH 7.5, indicating that fava protein achieves sufficient repulsion at a lower pH. Without limitation to theory, this may explain the variation in optimal pH values for microgel formation between the two pulse proteins.

After heating, the surface charge of the lentil protein slightly decreased to −29.5 mV, while that of the lentil microgel was −26.1 mV. Similar slight reductions in zeta potential are observed during fava microgel formation. The zeta potential of native fava protein (pH 7.5) was −38.0 mV, with a slight decrease observed after heating to −37.8 mV, and further decreased to −30.9 mV for fava microgel. Lentil and fava proteins demonstrate a consistent decrease in absolute zeta potential after heat treatment, with a further drop after microgel formation.

High temperatures caused protein unfolding and rearranged surface charged amino acids, thus influencing the zeta potential. The heat treatment led to the burial of negatively charged residues, reducing the electrostatic repulsion and promote protein aggregation.

Compared to the heated proteins, the microgels show a statistically significant decrease in zeta potential. The microgels show greater structural conformation changes than heated protein, as confirmed by FTIR results (FIGS. 9A-9B), leading to altered exposure of charged groups or the bound counter-ions. Without limitation to theory, a possible reason is that the exclusive effect of polysaccharides increases the actual protein concentrations in the protein-rich phases and reach to the critical gelation concentration. Higher actual protein concentrations increase protein aggregation in microgels, burying more negatively charged residues and further reducing the zeta potential.

Although the zeta potential decreased after formation of the microgels, the absolute value of the microgels were still near or higher than the critical value of 30 mV to maintain the moderate stability. When used as the stabilizers for making emulsions, the relative high zeta potential values of these microgels can provide the electrostatic repulsion to prevent oil droplet aggregation.

iv. Protein Conformation Changes (FTIR)

Fourier transform infrared (FTIR) spectra of the plant protein microgels, heated protein solution and native protein solutions were recorded using a Nicolet 6700 FTIR spectrophotometer (Thermo Fisher Scientific Inc., MA, USA). Spectra data were collected in the wavelength rage of 4000-800 cm⁻¹ with 128 scans at a resolution of 4 cm⁻¹. Briefly, deuterium oxide (D₂O) was used to replace H₂O in sample preparation. The pH was adjusted using 6M NaOD.

The wet samples were placed between two transparent calcium fluoride (CaF₂) windows separated with a 25 μm polyethylene terephthalate film spacer. To analyze the amide I region, Fourier self-deconvolution (FSD) was performed using Omnic 8.1 software in the amide I band region from 1700 to 1600 cm⁻¹, with a bandwidth of 24 cm⁻¹ and an enhancement factor of 2.5.

In particular, the deconvoluted FTIR spectra of the amide I band region (1700 to 1600 cm⁻¹) was used to analyze the protein secondary structural changes during heating process and microgel formation (FIGS. 9A-9B).

The amide I band primarily originated from the C═O stretching vibration. Band assignments to different protein secondary structures as follows: 1607 cm⁻¹ related to vibration of amino acid residues, 1615 cm⁻¹, 1616 cm⁻¹, 1630 cm⁻¹, 1678 cm⁻¹ and 1682 cm⁻¹ to β-sheet, 1643 cm⁻¹ to α-helix and random coil, 1656 cm⁻¹ and 1658 cm⁻¹ to α-helix, 1689 cm⁻¹ to β-turn.

As shown in FIGS. 9A-9B, the native lentil protein possessed three significant bands at 1607 cm⁻¹, 1630 cm⁻¹ and 1689 cm⁻¹.

After heat treatment, the bands at 1607 cm⁻¹ and 1689 cm⁻¹ disappeared, and the absorption intensity at 1630 cm⁻¹ was decreased, accompanied with the appearance of two new peaks at 1615 cm⁻¹ and 1682 cm⁻¹. The band at 1615 cm⁻¹ was assigned to the intermolecular β-sheet, which indicated the formation of aggregates by strong hydrogen bonds.

Moreover, the band at 1682 cm⁻¹ was associated with antiparallel β-sheet formed by hydrogen bonds. This result indicates the protein unfolding and aggregation during heat treatment and significant hydrogen bonds are formed between the β-sheet structure, which contributes to the formation of microgels.

It is noted that the lentil microgels demonstrate higher absorption intensities at 1615 cm⁻¹ and 1682 cm⁻¹ compared to the heated lentil protein, indicating the higher degree of protein aggregation. During the microgel formation, the presence of polysaccharide could enhance the actual protein concentration in the protein-rich domain due to the excluded volume effect. This elevated protein concentration surpasses the minimal gelling threshold, leading to microgel formation.

The fava protein microgels also exhibited two prominent peaks at 1616 cm⁻¹ and 1682 cm⁻¹, indicating the microgels could be stabilized by hydrogen bonds through the formation of β-sheet structure.

v. Surface Hydrophobicity

The surface hydrophobicity (H0) of native protein solutions and heated protein solutions were determined using the fluorescent probe 1-anilinonaphthalene-8-sulfonic acid (ANS) [2].

The serial dilutions of protein solutions with concentrations from 0.0625 mg/ml to 1 mg/ml were prepared by diluting with 0.01M phosphate buffer (pH 7). Then, 10 μl of ANS solution (8 mM) was mixed with 1 ml of diluted protein solutions and incubated for 15 min in the dark.

The fluorescence intensity of the diluted protein solutions with and without ANS was measured using a SpectraMax™ M3 spectrometer (Molecular Devices, Sunnyvale, US). The excitation and emission wavelengths were set as 390 nm and 470 nm, respectively. The initial slope of the net fluorescence intensity (fluorescence intensity of protein solution with ANS minus fluorescence intensity of protein solution without ANS) versus the protein concentration ploy was regarded as surface hydrophobicity (H0).

In particular, the surface hydrophobicity (H0) of native and heated proteins was investigated using ANS as a fluorescence probe. Table 1 shows that the H0 values of lentil protein increased significantly from 778.7 to 2058.3 after heat treatment. Similarly, H0 of fava protein rose from 1172.9 to 2425.8 after thermal treatment.

TABLE 1
Surface hydrophobicity (H0), free-SH groups
of plant proteins and heated proteins

| Samples | H0 | Free-SH (μmol/g protein) |
|---|---|---|
| Lentil protein | 778.7 ± 1.2^{b} | 10.4 ± 0.4^{a} |
| Heated lentil protein | 2058.3 ± 51.7^{a} | 9.6 ± 0.6^{b} |
| Fava protein | 1172.9 ± 33.2^{b} | 14.8 ± 1.4^{a} |
| Heated fava protein | 2425.8 ± 80.3^{a} | 10.3 ± 0.9^{b} |

Heat treatments markedly increased the surface hydrophobicity of proteins by causing heat-induced denaturation, which exposed hydrophobic residues previously buried within the globular core of the proteins.

The exposed hydrophobic regions could trigger protein aggregation, which then promotes microgel formation. Hydrophobic interactions are more dependent on the non-polar amino acids such as alanine, glycine, leucine, isoleucine, valine and phenylalanine. In addition, hydrophilic amino acids such as aspartic acid, glutamic acid, serine and threonine are more likely to participate in hydrogen bonds formation. The polar groups on their sidechains were exposed during heat treatment that led to hydrogen bond formation as revealed by FTIR.

vi. Total Free Sulfhydryl (—SH) Content

The total free —SH group contents were measured using the method described by reference [2], with slight modifications.

The LPI, FPI and SPI were dissolved in Milli-Q water to achieve a protein concentration of 25 mg/ml. Then 0.4 ml of both native and heated (95° C. for 1 hour) protein solutions were mixed with 3.6 ml Tris-glycine buffer (0.09 M glycine, 0.086 M Tris, 0.004 M EDTA, 2.5% SDS, pH 8.0) to reach the final protein concentration of 2.5 mg/ml. An aliquot (2 ml) of samples was mixed well with 20 μl of Ellman's reagent (DTNB, 4 mg/ml in Tris-glycine buffer) and incubated for 15 min in the dark at room temperature. The absorbance was measured at 412 nm using a spectrometer (DLAB, SP-V1000), and the buffer was used as a blank. The total free-SH content (μmol SH/g protein) was calculated as:

$$μmol SH / g protein = ( 73.53 \times {A}_{412} \times D ) / C$$

where 73.53 is the molar absorptivity constant, A412 is the absorbance at 412 nm, D represent the dilution factor (2.02/2) and C represent the protein concentration (2.5 mg/ml).

In particular, after heat treatment, pulse proteins exhibited a significant reduction in total free sulfhydryl content (Table 1). Specifically, the lentil protein solution showed a decrease in total free-SH content from 10.43 μmol/g to 9.57 μmol/g. Similarly, the fava protein's total free sulfhydryl content decreased from 14.82 μmol/g to 10.28 μmol/g. The high temperature triggered the exposure of the sulfhydryl group of plant proteins, which oxidized and then form disulfide bonds. The formation of disulfide bonds provides an acting force in gel formation.

Therefore, unfolding of pulse proteins facilitated the formation of hydrophobic interaction, hydrogel bonds and disulfide bonds to stabilize the gel network. This explanation was supported by the results of surface hydrophobicity, FTIR and sulfhydryl content of plant proteins.

### V. EXAMPLE TEST RESULTS FOR CHARACTERIZATION OF OIL-IN-WATER (O/W) EMULSIONS

Oil-in-water emulsions were prepared by mixing canola oil with isolated lentil protein microgels suspensions (as prepared in accordance with the description above) to have the oil concentration of 25% and 50% (w/w) in the final emulsions. Then the mixtures were homogenized at 20000 rpm for 2 min by a high-speed homogenizer (IKA-Ultra-Turrax T25 basic, IKA® Works, Inc., Wilmington, NC, USA) at room temperature.

The protein concentrations of lentil microgels with different sizes were around 6-7% w/w. The protein concentrations in whole emulsion system were set as 1.5% w/w and 3% w/w.

The emulsions stabilized by 3% w/w heated lentil protein (pH 8.5) was prepared as control groups. All emulsions were stored at 4° C. for further analysis.

All experiments were performed at least in triplicates and results were presented as mean values±standard deviations. All statistical analysis were performed by the SPSS software (SPSS, INC., Chicago, IL, USA). T-test or one-way analysis of variance (ANOVA) with post hoc Tukey's test were used to determine the statistically significant differences between results. The p-value <0.05 was considered significant.

i. Visual Appearance and Stability

The emulsions were sealed and stored at 4° C. for a month. The creaming index (CI) was calculated to reflect the stability of the emulsions by the following equation:

$$CI ( \% ) = {H}_{S} / {H}_{O}$$

wherein H_{S} is the height of serum layer and H_{O} was the total height.

In a preliminary study, lentil and fava protein microgels showed comparable effectiveness in stabilizing emulsions. Lentil protein microgels were chosen as the representative for further analysis and demonstration of results.

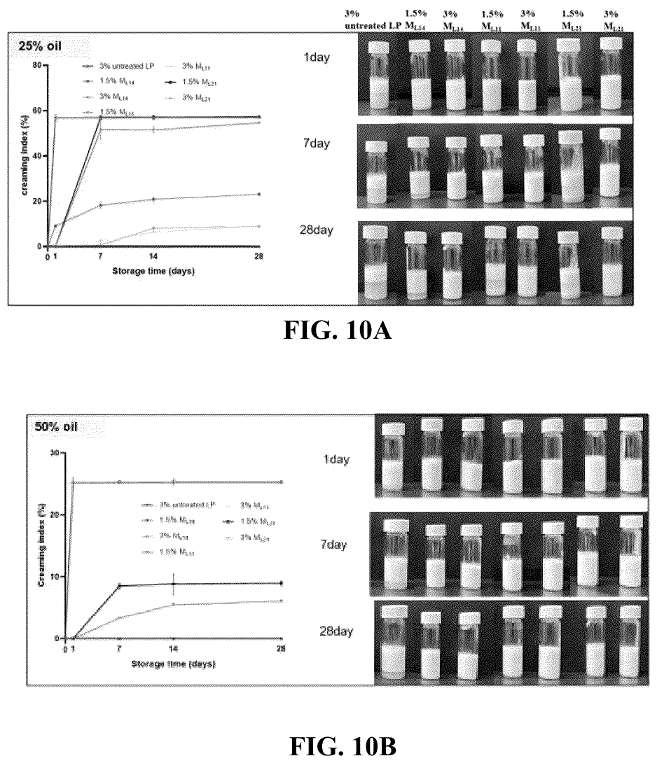

FIGS. 10A-10B present the visual appearances of emulsions stabilized by lentil protein microgels with varying oil concentrations (25% (FIG. 10A) and 50% (FIG. 10B), w/w) after 1 day, 7 day and one month of storage.

Untreated lentil protein-stabilized emulsions with 25% and 50% oil content demonstrated rapid phase separation and creaming after one hour of preparation. Without limitation to theory, this phenomenon can be partially attributed to the low viscosity of the emulsion system.

In emulsions with 25% oil (FIG. 10A), 3% microgel concentration led to less creaming and a higher emulsion phase compared to 1.5% microgel concentration. When compared to the microgels of different particle size, emulsions stabilized by 3% M_{L14} (3 μm) showed almost no creaming (Creaming index of 0%) after 28-day period storage.

While some level of creaming was observed for emulsions prepared with 3% M_{L11} (7 μm; Creaming index of 9.2%) and 3% M_{L21} (15 μm; Creaming index of 9.0%). The big difference was observed for emulsions stabilized with 1.5% microgels. For emulsions prepared with 1.5% M_{L14}, the creaming index was 18% after one week and increased to 22% after one month.

The emulsions also showed a top emulsion layer and a bottom serum layer. However, emulsions stabilized by 1.5% M_{L11} and M_{L21} demonstrated significantly higher creaming indexes of 54% and 57%, respectively.

It was noteworthy that these emulsions separated into three layers: a top cream layer, a middle serum layer and a bottom microgel layer, due to the gravitational separation. This phenomenon suggested that particle size of the microgels significantly impact the emulsion stability. Compared to larger M_{L11} (7 μm) and M_{L21} (15 μm) microgels, M_{L14} microgels (3 μm) could more effectively stabilize the emulsions at a lower oil volume fraction of 25%.

For emulsions with 50% oil volume fraction (FIG. 10B), all samples demonstrated superior stability than emulsions with 25% oil. Only slight creaming was observed for emulsions stabilized by 1.5% M_{L21} (Creaming index 6.1%) and 1.5% M_{L11} (Creaming index 9.2%) after one month storage, all other emulsions showed no creaming after one month storage.

ii. Confocal Laser Scanning Microscopy (CLSM)

The emulsions were imaged by CLSM to visualize the structure and behavior of the microgels in the emulsion system. The oil droplets were stained with Nile red (red), while protein microgels were stained with fast green (green).

In particular, a CLSM (Carl Zeiss Microscopy GmbH, Jena, Germany) was used to observe the microstructure of emulsions stabilized by lentil microgels. Before emulsions preparation, the Nile Red (1 mg/ml in dimethyl sulfoxide) was used to stain canola oil to achieve the final dye concentration of 0.02 mg/g oil, and fast green (1 mg/ml in Milli-Q water) was added to microgel suspensions to achieve the final dye concentration of 0.02 mg/g in aqueous phase. Then the emulsions were placed on a glass confocal microscope slide, covered by a glass coverslip, and observed by a confocal laser scanning microscope (Carl Zeiss Microscopy GmbH, Jena, Germany) with a 40× oil immersion objective lens. Nile red was excited at 488 nm, and emission was detected between 555 nm and 620 nm. The excitation wavelength for fast green was 633 nm, and the emission filters were adjusted to 660-710 nm specifically for fast green.

FIGS. 11(a) and (b) illustrated that M_{L14} microgels (3 μm) were absorbed at the oil-water interface, forming a Pickering emulsion.

At fluid interfaces, M_{L14} microgels (3 μm) behave between surfactants and solid particles. Unlike surfactants, microgels could irreversibly bind to the interface and do not follow dynamic equilibrium between absorption and desorption. Their larger size results in higher adsorption energy compared to surfactants. Compared to solid particles, microgels are compressible and deformable.

It is understood that microgels could form a “fried egg” structure upon adsorption to an interface, with the outer layers spreading while the dense center remained less deformed. Meanwhile, microgels could significantly reduce the surface tension due to its local amphiphilicity. Soft particles like microgels offer unique advantages as Pickering emulsion stabilizers over solid rigid particles. The softer microgel can stretch at the oil-water interface, and this deformation increase the absorption energy. Moreover, the soft particles can spread to cover a larger area of the oil-water interface. Lasty, microgels with local amphiphilicity can reduce the interfacial tension by adjusting their morphology.

As shown in FIGS. 11(c) and (d), the microgels M_{L11} (7 μm) were dispersed in the bulk phase. Larger microgels exhibited a lower diffusion coefficient compared to smaller microgels (M_{L14}, 3 μm), resulting in slower dispersion to the interface and reduced adsorption efficiency.

The differences in microgel size led to two different emulsion stabilization mechanisms. The smaller M_{L14} microgels attached to the oil/water interface and formed Pickering emulsions. However, the larger M_{L11} and M_{L21} microgels dispersed in the continuous phase, providing steric hindrance (gelling effect) to stabilize the emulsion system.

Both the Pickering effect at the surface (M_{L14}) and gelling effect in the continuous phase (M_{L11} and M_{L21}) contributed to the emulsions' stability, as they both demonstrated lower creaming indexes than untreated lentil protein (FIG. 10). However, Pickering emulsions demonstrate greater effectiveness, especially at low oil volume fractions. The most essential stabilization mechanism was the interfacial membrane barrier mechanism, where microgels form a single or multilayer around droplets, preventing their deformation and aggregation. Meanwhile, the three-dimensional grid mechanism might occur when the microgels form a network around the oil droplets. This network slowed the movement of the oil droplets and increased the system's viscosity.

iii. Droplet Size Measurement

The oil droplet size was measured using a Mastersizer 3000 (Malvern Instruments Ltd., Worchester, UK). The refractive index of the canola oil and dispersion medium were set as 1.445 and 1.33, respectively. The average droplet size was reported as volume mean diameter (d_{4,3}).

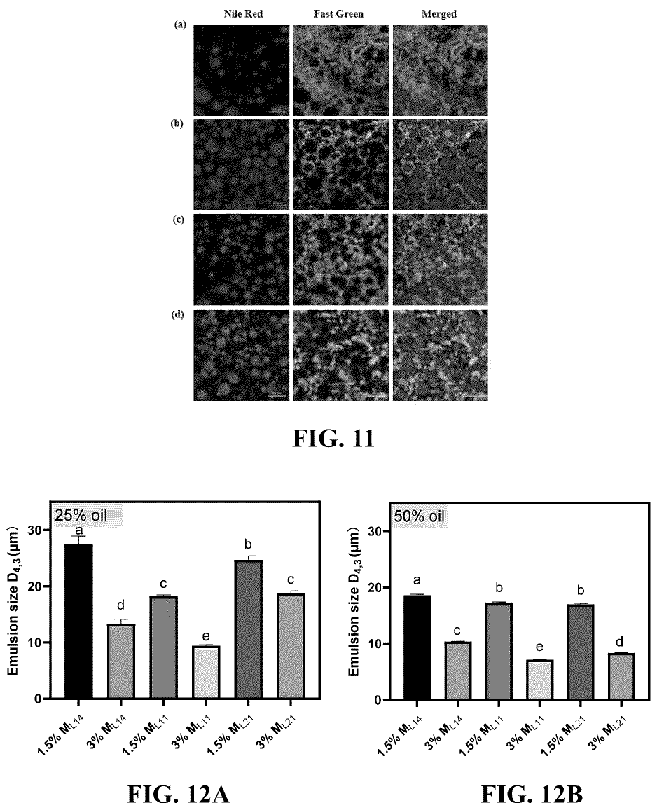

FIGS. 12A-12B shows the emulsion droplet size (d_{4,3}) of the prepared emulsions. For emulsions with 25% oil volume fraction, as microgel concentrations increased from 1.5% to 3%, the d_{4,3} values significantly decreased from 27.5 to 13.3 μm (M_{L14}, 3 μm), from 18.2 to 9.4 μm (M_{L11}, 7 μm) and 24.7 to 18.7 μm (M_{L21}, 15 μm), respectively.

A similar trend was observed for emulsions with 50% oil volume fraction, where the d_{4,3} values significantly decreased from 18.6 to 10.4 μm for M_{L14}, from 17.3 to 7.1 μm for M_{L11} and 17.0 to 8.4 μm for M_{L21} as microgel concentrations increased from 1.5% to 3%. These results suggested that higher microgel concentrations led to smaller oil droplet sizes, as more particles or free proteins were available to cover a larger surface area of the oil droplets.

Compared to emulsion stabilized by M_{L11} and M_{L21} microgels, M_{L14} stabilized emulsions generally exhibited a slightly larger oil droplet size due to bigger particle size and slower absorption rate of protein microgels compared to free proteins.

iv. Rheological Properties

Rheology focuses on the flow and deformation of the emulsions, and it provides information about the structural changes and interactions of emulsions. The rheology of emulsion is also associated with its stability and applications.

The rheological properties of the emulsions were characterized using a DHR-3 rheometer (TA Instruments, New Castle, DE, USA) with a stainless-steel parallel plate geometry (a diameter of 40 mm) at 25° C. The soaking time was set as 100 s before each experiment. The gap was set at 500 μm. Each rheological measurement was replicated three times.

### Shear Rates

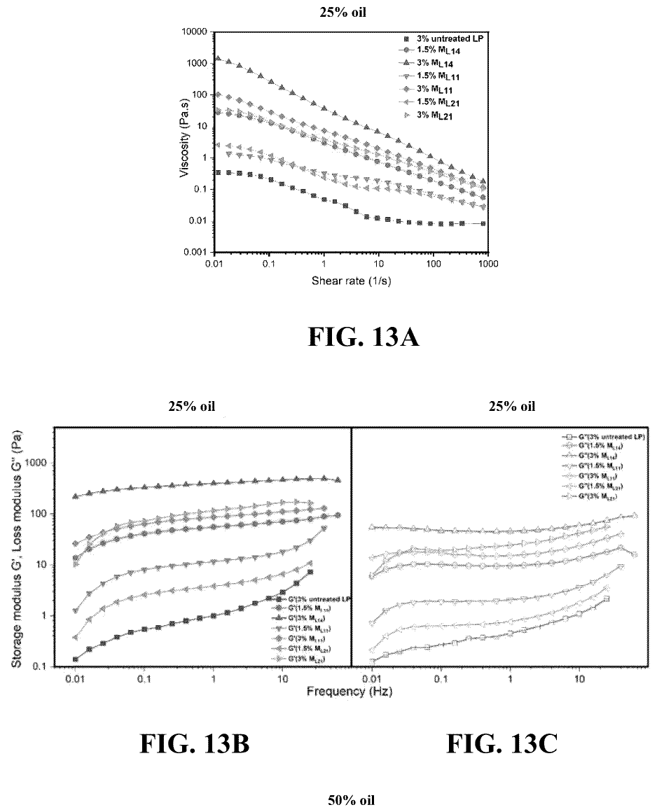

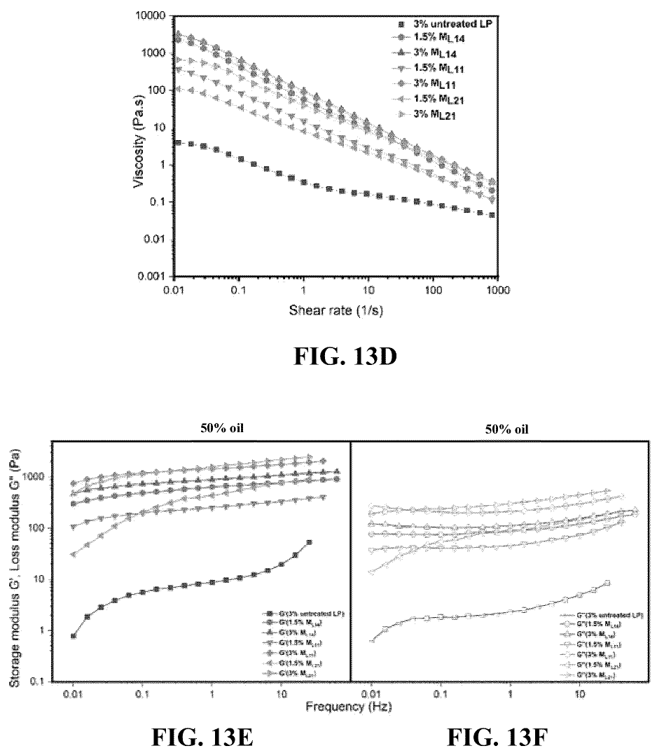

The apparent viscosity of prepared emulsions was determined at the shear rates from 0.001 to 1000 s⁻¹ (FIGS. 13A and 13D). The viscosities of two control emulsions prepared from 3% untreated lentil proteins at the oil volume fraction of 25% and 50% are also analyzed under the same conditions.

More generally, the flow behavior was analyzed using shear rate from 0.001 to 1000 s⁻¹. The power law model was applied to estimate the shear rate dependence of viscosity in the emulsions (reference [3], incorporated herein in its entirety by reference).

The OriginPro software (OriginLab Corp., Northampton, MA, USA) was used to fit the experimental flow curves by the Power law model as follows:

$$η = K {\dot{γ}}^{n - 1}$$

wherein η is the apparent viscosity (Pa·s), K is the consistency coefficient (Pa·sⁿ), \dot{γ} is the shear rate (s⁻¹), and n represents the dimensionless flow behavior index.

The Power law model is applied to fit the flow curves with R²>0.98. The consistency coefficient (K) and flow behavior index (n) are summarized in Table 1. The apparent viscosity decreased with the increase in the shear rate for all flow curves, and the flow behavior index (n) was <1, indicating that all emulsions exhibited the shear-thinning behavior (Table 2). They were regarded as the pseudoplastic non-Newtonian fluids. The increased shear rate caused droplet deformation and/or disruption, leading to decreased viscosity.

TABLE 2
Rheological fitting parameters from flow curves of O/W emulsions

| | 25% oil | | | 50% oil | | |
|---|---|---|---|---|---|---|
| Emulsions | K (Pa · sⁿ) | n | R² | K (Pa · sⁿ) | n | R² |
| 3% untreated LP | 0.010 ± 0.001^{e} | 0.975 ± 0.014^{a} | 0.999 ± 0.000 | 0.353 ± 0.018^{g} | 0.685 ± 0.005^{a} | 1.000 ± 0.000 |
| 1.5% M_{L14} | 2.875 ± 0.412^{cd} | 0.406 ± 0.012^{e} | 1.000 ± 0.000 | 59.165 ± 2.687^{c} | 0.160 ± 0.007^{d} | 0.990 ± 0.001 |
| 3% M_{L14} | 42.806 ± 2.344^{a} | 0.180 ± 0.008^{g} | 0.990 ± 0.003 | 97.716 ± 3.625^{a} | 0.151 ± 0.003^{d} | 0.989 ± 0.002 |
| 1.5% M_{L11} | 0.478 ± 0.020^{de} | 0.568 ± 0.003^{c} | 0.999 ± 0.000 | 17.629 ± 2.036^{e} | 0.256 ± 0.011^{c} | 0.997 ± 0.002 |
| 3% M_{L11} | 8.271 ± 0.220^{b} | 0.359 ± 0.005^{f} | 0.999 ± 0.001 | 89.336 ± 3.631^{b} | 0.175 ± 0.001^{d} | 0.982 ± 0.004 |
| 1.5% M_{L21} | 0.329 ± 0.034^{e} | 0.636 ± 0.015^{b} | 0.999 ± 0.000 | 9.474 ± 1.828^{f} | 0.355 ± 0.025^{b} | 0.998 ± 0.001 |
| 3% M_{L21} | 4.315 ± 0.133^{c} | 0.441 ± 0.006^{d} | 1.000 ± 0.000 | 39.696 ± 2.726^{d} | 0.286 ± 0.011^{c} | 0.990 ± 0.009 |

The higher the K values, the greater the resistance to flow. When fixing the oil volume fraction at 25%, compared to emulsions prepared from untreated 3% lentil proteins (K=0.01 Pa·sⁿ), emulsions stabilized by microgels had significantly higher K values (0.3-42.8 Pa·sⁿ), indicating the incorporation of microgels could form emulsions with stronger structures and these emulsions are thicker and more difficult to flow (FIG. 13A and Table 2).

A similar phenomenon is observed when the oil content was 50%, the K value increased dramatically from 0.35 Pa·sⁿ (control sample) to 9.4-97.7 Pa·sⁿ. The increased K values were accompanied by the decreased n values, indicating that microgel-stabilized emulsions demonstrated stronger shear-thinning behaviors (FIG. 13D and Table 2), which carries practical advantages.

These emulsions exhibited high viscosities at low shear rates to prevent from creaming and maintain stability, and the viscosity decreased at higher shear rate making them easier to pour out of a container.

Among four emulsions prepared from microgels with same size, emulsions with 25% oil volume fraction and 1.5% microgels had the lowest K values and highest n values (Table 2). Meanwhile, these emulsions all demonstrated higher creaming indexes after 1 week storage. This further support the discussion above that the lower viscosity led to higher creaming index observed for emulsions prepared by untreated lentil protein. The decreased emulsion viscosity could increase the velocity and encounter rate of oil droplets, they tend to go through gravitational separation and droplet aggregation.

The enhancement of oil volume fraction (from 25% to 50%) or the microgel concentration (from 1.5% to 3%) could dramatically increase the consistency coefficients and viscosities. It is understood that droplet size plays an important role in viscosity. The smaller droplets result in greater interfacial area, therefore enhancing the friction between them and ultimately leading to high viscosity.

The higher oil content or microgel content could decrease the oil droplet sizes and increase the interfacial area. Moreover, the increased oil and microgel contents could result in “jamming effect” or “filler effect”, which could limit the movement or interaction of oil droplets and form a more densely packed and stronger network. This leads to enhanced K values and stability. When fixing the oil content at 50%, all emulsions stabilized by 3% microgels demonstrated excellent storage stability without phase separation after 1 month storage. Therefore, the increased viscosity could reduce the creaming velocity and enhance the emulsion stability.

The microgel size also plays an important role in influencing the viscosity of emulsions.

With the same emulsion formation, emulsions stabilized by the smallest microgels (M_{L14}, 3 μm) had the highest K values (2.9-97.7 Pa·sⁿ) and lowest n values, while the largest microgels (M_{L21}, 15 μm)—stabilized emulsions demonstrated lowest K values (0.3-39.7 Pa·sⁿ) and highest n values. One possible explanation was that M_{L14} formed Pickering emulsions, while the microgels with bigger size were less efficient at attaching to the oil surface (CLSM images).

It is observed that Pickering emulsions exhibited the highest viscosity because microgels tightly adsorbed at the oil-water interface, forming a strong elastic interfacial film that prevented droplet coalescence, while excess microgels in the continuous phase created a 3D network around the droplets, limiting their movement.

A high oil content is normally required for desirable consistency and texture in food applications such as salad dressing and cream; however, excessive fat intake can increase the risk of health problems, and fats are vulnerable to oxidation.

It is worth noting that when fixing the protein concentration at 3%, microgels-stabilized emulsions with 25% oil achieved significantly higher K values (4.3-42.8 Pa·sⁿ) than controlled emulsions stabilized by 3% untreated lentil protein with 50% oil (K=0.4 Pa·sⁿ). This indicates that the microgels could replace fat to achieve the viscosity of the emulsion systems to provide required sensory attributes and texture. Pickering emulsions stabilized by M_{L14} (3 μm) showed a more solid-like behavior, making them suitable for viscoelastic products such as yogurt and cream. In contrast, emulsions stabilized by M_{L11} (7 μm) and M_{L21} (15 μm) showed more liquid-like behavior, making them ideal for low-viscosity fluids such as salad dressing and milk.

### Frequency Sweep Test

The frequency sweep test was conducted to evaluate the viscoelastic characteristics of these emulsions (FIGS. 13B-13C and 13E-13F). The storage modulus (G′) and loss modulus (G″) are determined by the elastic and viscous properties, respectively. With G′>G″ for all emulsions, all emulsions had predominant elastic behaviors.

More generally, the relationship between viscoelastic modulus and angular frequency (ω) was studied by a frequency sweep test. The storage modulus (G′) and loss modulus (G″) of the emulsions were determined over the angular frequency range of 0.01-100 Hz with the constant strain of 1%, the applied strain was within the linear viscoelasticity region. A Power law model was used to estimate the angular frequency dependence of storage modulus. The elastic modulus (G′, Pa) and angular frequency (ω, Hz) were fitted to the Power law model via the OriginPro™ software by the following equation:

$${G}^{′} = a {ω}^{n}$$

where a is the Power law constant and n is the frequency exponent.

The storage modulus of emulsions was measured to evaluate the structural strength of the emulsions. A Power law model was used to estimate the angular frequency dependence of storage modulus, and fitted parameters were summarized in Table 3. The power law constant “a” represents the G′ value at angular frequency of 1 Hz and indicates the stiffness of the emulsions. The frequency exponent “n” relates to frequency dependence, and n=0 represents frequency independence and a true elastic gel, while the increasing n value represents a more viscous system.

Compared to emulsions stabilized by 3% native lentil proteins, emulsions stabilized by microgels had dramatically increased K values and reduced n values (Table 3). Regardless of oil content, when increasing the microgel concentration from 1.5% to 3%, the a value of emulsions significantly enhanced, along with the deceased n value (Table 3), indicating the addition of microgels can change emulsions from a viscous state to a more gel-like solid state.

TABLE 3
Rheological fitting parameters from frequency sweep curves of O/W emulsions

| | 25% oil | | | 50% oil | | |
|---|---|---|---|---|---|---|
| Emulsions | a (Pa) | n | R² | a (Pa) | n | R² |
| 3% untreated LP | 0.693 ± 0.089^{c} | 0.429 ± 0.133^{a} | 0.955 ± 0.049 | 11.889 ± 2.824^{f} | 0.387 ± 0.053^{a} | 0.960 ± 0.022 |
| 1.5% M_{L14} | 51.817 ± 0.010^{bc} | 0.139 ± 0.006^{b} | 0.952 ± 0.001 | 541.913 ± 56.925^{d} | 0.109 ± 0.011^{b} | 0.969 ± 0.014 |
| 3% M_{L14} | 410.029 ± 52.915^{a} | 0.085 ± 0.004^{b} | 0.967 ± 0.011 | 951.733 ± 86.602^{c} | 0.087 ± 0.008^{b} | 0.978 ± 0.008 |
| 1.5% M_{L11} | 10.318 ± 1.281^{c} | 0.219 ± 0.020^{ab} | 0.929 ± 0.038 | 272.365 ± 26.404^{e} | 0.123 ± 0.014^{b} | 0.983 ± 0.002 |
| 3% M_{L11} | 84.794 ± 5.955^{b} | 0.148 ± 0.016^{b} | 0.963 ± 0.013 | 1340.022 ± 120.00^{b} | 0.096 ± 0.003^{b} | 0.985 ± 0.006 |
| 1.5% M_{L21} | 4.135 ± 0.281^{c} | 0.248 ± 0.002^{ab} | 0.927 ± 0.058 | 418.972 ± 45.092^{de} | 0.225 ± 0.032^{ab} | 0.964 ± 0.009 |
| 3% M_{L21} | 129.127 ± 19.485^{b} | 0.236 ± 0.056^{ab} | 0.926 ± 0.005 | 1686.355 ± 157.042^{a} | 0.147 ± 0.002^{b} | 0.980 ± 0.001 |

The microgel contributed to generate a more viscoelastic network, this was because the microgels could aggregate with each other by the hydrophobic interaction. According to the CLSM figures, the aggregation of M_{L14} (3 μm) could absorb at the oil-water interface, while the M_{L11} (7 μm) and M_{L21} (15 μm) and excessive M_{L14} could aggregate in the continuous phase. The results show that the storage modulus increased with higher microgel concentration.

The reason was that the interaction force enhanced between the microgel particles on the droplet's surface and in the aqueous phase. The incorporation of higher concentrations of microgels could form emulsions with stronger structures that are more resistant to flow. Such properties make these microgel-stabilized emulsions potential substitutes for butter and yogurt, where a thicker, more stable consistency is desirable for achieving the required texture and mouthfeel.

Moreover, the increased oil concentration from 25% to 50% also dramatically increased a values and decreased n values. The reduction in oil droplet sizes leads to a higher packing density of droplets, which may enhance the strength of the emulsion. Previous studies also demonstrated that higher oil contents contribute to the elastic behavior of emulsions, the potential reason was due to a higher density of cross-links between the droplets.

The emulsions stabilized by M_{L14} had the lowest n values (0.085-0.139), indicating the storage modulus was almost independent of frequency, and they formed a stronger gel-like emulsion. The main reason was that the M_{L14} adsorbed to the oil-water interface with high absorption energy, forming a stronger layer around the oil droplets. The smallest microgels on the oil surface may contribute to form a three-dimensional network.

### VI. INTERPRETATION

Various systems or methods have been described to provide an example of an embodiment of the claimed subject matter. No embodiment described limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described is not an embodiment that is recited in any claimed subject matter. Any subject matter disclosed in a system or method described that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

### VII. REFERENCES

All publications, patents and patent applications mentioned in this specification, and/or listed below, are indicative of the level of skill of those skilled in the art to which this invention pertains and are herein incorporated by reference to the same extent as if each individual publication, patent, or patent applications was specifically and individually indicated to be incorporated by reference. The reference numbers below correspond to reference numbers mentioned in the specification above.
[1] Chu, Y., Jo, Y., & Chen, L. (2022). Size-controllable core/shell whey protein microgels with narrow particle size distribution fabricated by a facile method. Food Hydrocolloids, 124. https://doi.org/10.1016/j.foodhyd.2021.107316.
[2] Alavi, F., Chen, L., & Emam-Djomeh, Z. (2021a). Effect of ultrasound-assisted alkaline treatment on functional property modifications of faba bean protein. Food Chemistry, 354. https://doi.org/10.1016/j.foodchem.2021.129494.
[3] Alavi, F., & Chen, L. (2022). Complexation of nanofibrillated egg white protein and low methoxy pectin improves microstructure, stability, and rheology of oil-in-water emulsions Food Hydrocolloids, 124. https://doi.org/10.1016/j.foodhyd.2021.107262.
[4] Alavi, F., Chen, L., & Emam-Djomeh, Z. (2021b). Structuring of acidic oil-in-water emulsions by controlled aggregation of nanofibrillated egg white protein in the aqueous phase using sodium hexametaphosphate. Food Hydrocolloids, 112. https://doi.org/10.1016/j.foodhyd.2020.106359.

1. A microgel comprising pulse proteins having a monodisperse particle size between about 3 μm and about 20 μm.

2. The microgel of claim 1 formed by segregative phase separation with a solution of proteins and a solution of polysaccharide at a pH above the isoelectric point of the proteins.

3. The microgel of claim 1 wherein the pulse proteins comprise lentil and/or fava bean proteins.

4. The microgel of claim 2 wherein the pulse proteins comprise lentil and/or fava bean proteins and the polysaccharide comprises alginate.

5. The microgel of claim 2 wherein the microgels have a particle size between about 3 μm and about 7 μm.

6. A method for preparing size-controllable pulse protein microgels comprising:
mixing a source of pulse protein with a source of polysaccharides to form pulse protein particles via segregative phase separation; and
heating the mixture to induce particle gelation; and
isolating the microgel particles.

7. The method of claim 6, comprising the further step of heating the mixture for protein denaturation to increase thermodynamic incompatibility prior to gelation.

8. The method of claim 6 wherein the pulse protein source comprises lentil and/or fava proteins; and/or the polysaccharide source comprises alginate.

9. The method of claim 6 wherein the segregative phase separation occurs at a pH at or above the isoelectric point of the protein.

10. The method of claim 9 wherein the microgel size is controlled by the mass ratio of protein to polysaccharide in the mixture.

11. The method of claim 10 wherein the mass ratio of protein to polysaccharide is between about 1:4 to about 12:1.

12. The method of claim 11 wherein the mass ratio is between about 5:4 to about 10:1.

13. An edible emulsion comprising a microgel of claim 1.

14. The emulsion of claim 13 which is an oil-in-water Pickering emulsion.

15. The emulsion of claim 10 which comprises between about 25% to about 50% oil (volume).

16. A method of stabilizing an oil-in-water emulsion comprising the step of adding an amount of the microgel of claim 1.

17. A method of stabilizing an oil-in-water emulsion comprising the step of adding an amount of the microgel produced by the method of claim 6.
